(19) United States
(12) Patent Application Publication
(10) Pub. No.: US 2023/0134594 A1
(43) Pub. Date: May 4, 2023

(54) UNSATURATED FLUXING AGENTS FOR BITUMINOUS BINDERS

(71) Applicant: VINCI CONSTRUCTION, Rueil Malmaison (FR)

(72) Inventors: Thomas LEBARBE, Audenge (FR); Frédéric DELFOSSE, Pessac (FR); Marie-Laure PIERRE, Villenave D'ornon (FR); Sophie RAS, Merignac (FR)

(73) Assignee: VINCI CONSTRUCTION, Rueil Malmaison (FR)

(21) Appl. No.: 17/799,520

(22) PCT Filed: Feb. 12, 2021
(86) PCT No.: PCT/FR2021/050259

§ 371 Date: Aug. 12, 2022

(30) Foreign Application Priority Data
Feb. 13, 2020 (FR) FR2001418

(51) Int. Cl. C04B 26/26; C04B 24/04

(52) U.S. Cl. CPC C04B 26/26; C04B 24/045; C04B 2111/0075

(57) ABSTRACT

The present patent application concerns the use of at least one compound of formula (I):

R¹—O—C(O)—R² (i)

in which:
R¹ is a linear or branched C₁-C₆ alkyl group, and
R² is a linear or branched hydrocarbon chain comprising from 2 to 13 carbon atoms and one or more unsaturations, the said unsaturation(s) being one or more carbon-carbon double bonds,
   as a fluxing agent for hydrocarbon binders.

### FIELD OF THE INVENTION

The present invention is concerned with the field of fluxing agents for hydrocarbon binders, which can be in particular used in road applications. More precisely, the invention concerns the use, as a fluxing agent for a hydrocarbon binder, of a compound of formula (I) as defined below, and its use in a method for the preparation of a bituminous product.

### BACKGROUND OF THE INVENTION

In so-called “bituminous” products, mineral particles are bound by a hydrocarbon binder, especially a bitumen. The hydrocarbon binders used in bituminous products are highly viscous, typically viscoelastic, products, which require, in order to be handled, to be heated, emulsified and/or additivated by so-called “fluxing” compounds. Fluxing agents make it possible, among other things, to reduce their viscosity. These fluxing agents can be of petroleum, carbochemical or even vegetable origin.

The usual fluxing agents are those of petroleum origin, which include:
“petroleum fluxing agents”, which are products from the distillation of crude petroleum (light fraction(s)), which may have undergone a hydrotreating operation. For example, mention can be made of the fluxing agents marketed by Total (Greenflux® 2000, Greenflux® SD in particular).
“petrochemical fluxing agents”, which are products from the distillation of crude petroleum (light fraction(s)), having undergone at least one thermal cracking and additional distillation operation. For example, mention can be made of the fluxing agents marketed by VFT France (Adheflux®).

Fluxing agents of petroleum origin are very satisfactory in terms of results. Indeed, when they are added to a hydrocarbon binder, they make it possible to lower the viscosity of the binder occasionally while generally ensuring that the mechanical performance of the bituminous product based on this fluxed hydrocarbon binder is not significantly deteriorated and thus makes it suitable for road use, in particular with sufficient cohesion rise.

These fluxing agents of petroleum origin are volatile products: after their incorporation into the hydrocarbon binder, where they ensure the desired reduction in viscosity, they evaporate, whereby the binder substantially regains its original characteristics. However, these released fluxing agents have many negative environmental impacts. In addition, their use is dangerous and uncomfortable (noxious and unpleasant vapours and danger of flammability).

Other volatile fluxing agents are fluxing agents of carbochemical origin which are products from coal pyrolysis, having undergone at least one distillation operation, which have the major disadvantage of being recognised as carcinogenic.

Application FR 3 068 702 describes the use of saturated monoesters with so-called short chains, that is, typically lower than C₁₆, for example C₁₂ or C₁₃, as volatile fluxing agents which, once incorporated into a hydrocarbon binder and before their evaporation, make it possible to reduce the viscosity of the hydrocarbon binder and to limit the disadvantages of the usual volatile fluxing agents in terms of repercussions on the environment and toxicity for their handler.

To replace volatile fluxing agents of petroleum origin, fluxing agents of natural non-fossil origin (vegetable or animal origin) have been provided, which avoid the release of noxious volatile organic compounds. A fluxing agent of non-fossil natural origin is a non-fossil natural oil, a derivatives thereof such as fatty acid esters, or a mixture of two or more such oils and/or oil derivatives. In particular, mention can be made of vegetable oils such as sunflower, rapeseed, peanut, copra, linseed, palm, soybean, olive, castor, corn, pumpkin, grape seed, jojoba, sesame, walnut, hazelnut, China wood, tall oil, derivatives thereof, and mixtures thereof. These oils comprise unsaturated fatty acids with at least 16 carbon atoms (C₁₆ or more). Such fluxing agents are for example described in applications FR 2 910 477, EP 0 900 822, FR 2 721 043 or FR 2 891 838. With non-volatile fluxing agents of the above-mentioned oil type, the increase in consistency of the binder in the final product (after spreading or coating) does not occur by evaporation, but by cross-linking, typically as a result of radical reactions, with unsaturated fatty chains reacting in the presence of oxygen from the air. These reactions, which can be catalysed by the addition of drying agents such as metal salts, comprise the formation of —O—O— peroxide bridges on the unsaturated chains. These bridges are unstable and lead to the formation of free radicals which in turn react with other unsaturations in other chains. This fluxing agent cross-linking technique therefore only applies to unsaturated compounds. The selection of the fluxing agent is based on the iodine value, which characterises the level of unsaturations of a compound and therefore its capacity to react by siccativation.

Although they present less risk for the environment or the well-being and health of the handlers, fluxing agents of natural non-fossil origin with a long chain, that is, at least C₁₆, are nevertheless less satisfactory than fluxing agents of petroleum origin in terms of results. Indeed, the results of cohesion rise are less good. Most of the time they lead to disorders in the event of showers, heat or too dense traffic, problems of bleeding, especially related to poor adhesion of the fluxed hydrocarbon binder to the solid mineral particles.

Thus, bituminous products prepared using existing fluxing agents of natural non-fossil origin are currently considered unadapted to moderate to heavy traffic and climatic variations.

There is therefore a need for new fluxing agents, in particular of vegetable origin, having equivalent performance to that of fluxing agents of petroleum origin but not leading to the release of volatile organic compounds which may present a risk to the environment or health.

### BRIEF DESCRIPTION OF THE INVENTION

In a first aspect the invention is related to the use of at least one compound of formula (I):

R¹—O—C(O)—R² (I)

in which:
R¹ is a linear or branched C₁-C₆ alkyl group, and
R² is a linear or branched hydrocarbon chain comprising from 2 to 13 carbon atoms and one or more unsaturations, said unsaturation(s) being one or more carbon-carbon double bonds,

as a fluxing agent for a hydrocarbon binder.

In a second aspect the invention relates to a method for preparing a bituminous product comprising solid particles and a hydrocarbon binder, said method comprising a step of contacting the hydrocarbon binder, the solid particles and at least one compound of formula (I) as described above and below.

### DETAILED DESCRIPTION OF THE INVENTION

To that end, one object of the invention is the use, as a fluxing agent, of at least one compound of formula (I):

R¹—O—C(O)—R² (I)

in which:
R¹ is a linear or branched C₁-C₆ alkyl group, and
R² is a linear or branched hydrocarbon chain comprising from 2 to 13 carbon atoms and one or more unsaturations, said unsaturations being carbon-carbon double bonds.

The invention is directed in particular to the use, as a fluxing agent, of at least one compound of formula (I):

R¹—O—C(O)—R² (I)

in which:
R¹ is a linear or branched C₁-C₆ alkyl group, and
R² is a linear or branched hydrocarbon chain comprising from 5 to 13 carbon atoms and one or more unsaturations, said unsaturations being carbon-carbon double bonds.

The compound of formula (I) may be used alone or in admixture with one or more other compounds of formula (I) and/or one or more other fluxing agents which may be fluxing agents commonly used in the technical field or as described for example in document FR 3 068 702.

In the present description, unless otherwise stated, the term “a compound of formula (I) or “the compound of formula (I)” refers to a compound of formula (I) used alone or a mixture of compounds of formula (I).

The compounds of formula (I) can be used in a method for preparing a bituminous product comprising solid particles and a hydrocarbon binder. Thus, the present invention also relates to a method for preparing a bituminous product comprising solid particles and a hydrocarbon binder, said method comprising a step of contacting a hydrocarbon binder, solid particles and a compound of formula (I) as described herein.

Contacting the hydrocarbon binder, solid particles and compound of formula (I) may comprise the following steps of:
(a) adding a compound of formula (I) to the hydrocarbon binder;
(b) contacting the hydrocarbon binder with the solid particles.

The contacting steps may be carried out in the sequential order of one and/or other of the following three alternatives:
alternative 1: step a) and then step b), characterised in that step b) is carried out before complete evaporation of the compound of formula (I) from the hydrocarbon binder,

and/or
alternative 2: steps a) and b) are carried out concomitantly,

and/or
alternative 3: step b) and then step a).

Contacting may also comprise a combination of these different alternatives.

When alternative 3 is implemented, it is understood that in step (a), the compound of formula (I) is added to the mixture comprising the binder and the solid particles.

Thus, the compound of formula (I) is always present within the hydrocarbon binder during all, or part, of the period of time that said hydrocarbon binder is contacted with the solid particles.

When alternative 1 is implemented, the compound of formula (I) is therefore still present at least in part in the binder when it is contacted with the solid particles, preferably in an amount sufficient to ensure its role as fluxing agent.

It should be noted that when alternative 2 and/or 3 is used, it can be contemplated to use, in a preliminary step (E0), compounds of formula (I) as fluxing agents in the binder, and then to let the used compounds of formula (I) evaporate completely before implementing one and/or other of alternatives 2 and 3. In this case, in order to implement alternative 2 and/or 3, compounds of formula (I), identical to or different from those used in the previous step (E0), will be introduced together with and/or after mixing the binder with the solid particles.

The inventors' work has shown that the compounds of formula (I), alone or as admixture, are volatile within a hydrocarbon binder, in particular of the bitumen type, and make it possible, once they have been incorporated into a hydrocarbon binder and before their evaporation, to reduce the viscosity of the hydrocarbon binder, which can then be implemented more easily.

The compounds of formula (I) therefore provide an effect similar to fluxing agents of petroleum origin, but without the problems of their impact on the environment and of toxicity for the handler.

Besides, the compounds of formula (I), before their evaporation, not only ensure an occasional reduction in the viscosity of the hydrocarbon binder, but also a good wettability of the solid particles, for example mineral solid particles, by the hydrocarbon binder, typically in the same order as that of the best fluxing agents currently used, such as Greenflux® SD.

The compounds of formula (I) also provide satisfactory adhesiveness, typically in the same order as those obtained with the best fluxing agents currently used.

The addition of one or more compounds of formula (I) to the hydrocarbon binder therefore makes it possible to obtain a hydrocarbon binder with good workability (transient reduction in viscosity) and providing satisfactory wettability and adhesiveness with respect to the solid particles, for example solid mineral particles, to which it is added, and without releasing volatile organic compounds that could present a risk to the environment or health. Besides, the compounds of formula (I) have better fluxing properties than the saturated volatile monoesters described in application FR 3 068 702. Advantageously, the compounds of formula (I) according to the invention also make it possible to obtain an efficient hydrocarbon binder after stabilisation (this performance is seen through the results of penetrability and ball-ring temperature).

The following definitions will be adopted throughout this description.

### Hydrocarbon Binder:

The term “hydrocarbon binder” or “binder” as used in this description refers to any hydrocarbon binder of fossil or vegetable or synthetic origin that can be used to make so-called “bituminous” products.

The hydrocarbon binder may be pure, additivated, especially by adding additives commonly used in the road field, for example adhesiveness enhancers or vegetable or petrochemical waxes, or it may be modified, especially by adding polymers.

The hydrocarbon binder may be a soft to hard binder, advantageously with a grade ranging from 10/20 to 160/220.

In some embodiments, the hydrocarbon binder is a pure, additivated or modified as described above bitumen.

The bitumen-modifying “polymers” referred to herein may be selected from natural or synthetic polymers. They are, for example, polymers from the family of synthetic or natural elastomers, and, by way of non-limiting indication:
statistical, multibiock or star copolymers of styrene and butadiene or isoprene in any proportion (in particular styrene-butadiene-styrene (SBS), styrene-butadiene (SB, SBR for styrene-butadiene rubber), styrene-isoprene-styrene (SIS) block copolymers or copolymers of the same chemical family (isoprene, natural rubber, . . . ), possibly cross-linked in-situ,
copolymers of vinyl acetate and ethylene in any proportion,
copolymers of ethylene and esters of acrylic acid, methacrylic acid or maleic anhydride, copolymers and terpolymers of ethylene and glycidyl methacrylate and polyolefins.

The bitumen-modifying polymers can be selected from recovered polymers, for example “rubber crumb” or other rubber-based compositions reduced to pieces or powder, for example obtained from used tyres or other polymer-based waste (cables, packaging, agricultural, etc.) or any other polymer commonly used for modifying bitumens such as those mentioned in the Technical Guide written by the World Road Association (AIPCR) and published by the Laboratoire Central des Ponts et Chaussées “Use of Modified Bituminous Binders, Special Bitumens and Bitumens with Additives in Road Pavements” (Pais, LCPC, 1999), as well as any mixture of these polymers in any proportion.

The hydrocarbon binder may be in anhydrous, emulsion or foam form.

When the hydrocarbon binder is in emulsion form, the hydrocarbon binder (bitumen, synthetic binder or vegetable-based binder) is dispersed in a continuous phase, typically an aqueous phase, for example water. A surfactant can be added to the emulsion to stabilise it.

During the manufacture of an emulsion, the hydrocarbon binder is dispersed in fine droplets in a continuous phase, for example in water, by mechanical action. The addition of a surfactant forms a protective film around the droplets, preventing them from agglomerating and thus allowing the mixture to be kept stable and stored for a certain period of time. The amount and type of surfactant added to the mixture determines the stability of the emulsion during storage and affects the curing time at the time of installation. The surfactant can be positively charged, negatively charged, amphoteric or non-ionic.

The surfactant is advantageously selected from surfactants of petroleum, vegetable or animal origin and mixtures thereof (for example the surfactant may be of vegetable and petroleum origin). The surfactant may be an alkaline soap of fatty acids: sodium or potassium salts of an organic acid (resin for example). The emulsion is then anionic. The surfactant may be an acid soap, which is generally obtained by the action of hydrochloric acid on one or two amines. The emulsion is then cationic. Among the surfactants relevant for road applications, mention can be made of the surfactants marketed by Akzo NOBEL (Redicote® E9, Redicote® EM 44, Redicote® EM 76), the surfactants marketed by CECA (Dinoram® S, Polyram® S, Polyram® L 80), the surfactants marketed by Meadwestvaco (Indulin® R33, Indulin® R66, Indulin® W5). These surfactants may be used alone or in mixtures.

The emulsion may contain synthetic or natural latex. By latex it is meant a dispersion of polymers (polyisoprene, SBS, SB, SBR, acrylic polymers, etc.) cross-linked or not in the aqueous phase. This latex is incorporated into the aqueous phase before emulsification or in line during the manufacture of the emulsion or after the manufacture of the emulsion. When the hydrocarbon binder is in the form of a foam, the foam is typically obtained by a method for injecting an amount of water, and possibly air, into the binder inlet, the water being pure or possibly including additives that make it possible to modify the adhesiveness or even rheological properties of the binder.

### Solid Particles

By “solid particles”, it is meant all solid particles that can be used to make bituminous products, particularly for road construction. Examples of solid particles include mineral solid particles such as natural mineral aggregates (pea gravels, sand, fines) for example from quarries or gravel pits, recycling products such as mix aggregates, for example resulting from the recycling of materials recovered during road repair or from the surplus of asphalt mixing plants, manufacturing scraps, “shingles” (from the recycling of roofing membranes), aggregates from the recycling of road materials including concrete, slag in particular dross, shale in particular bauxite or corundum, rubber crumb from tyre recycling especially, artificial aggregates of any origin and aggregates from for example household waste incineration clinker (HWI), as well as their mixtures in any proportion. The solid particles, in particular mineral solid particles, for example natural mineral aggregates, typically comprise:
elements smaller than 0.063 mm (filler or fines);
sand, the elements of which are between 0.063 mm and 2 mm;
pea gravels or aggregates, the elements of which have dimensions
   between 2 mm and 6 mm;
   larger than 6 mm.

The size of solid particles, in particular mineral solid particles, for example mineral aggregates, is measured by the tests described in NF EN 933-2 standard (version May 1996).

By “mix aggregates”, it is meant fragments of mixes (mixture of aggregates and bituminous binders) from the milling of mix layers, crushing of slabs extracted from mix pavements, pieces of mix slabs, mix waste or mix production surpluses (production surpluses are materials that have been coated or partially coated at the plant as a result of the transitory phases of manufacture). These and other recycling products can reach dimensions up to 31.5 mm.

“Mineral solid particles” are also referred to as the “mineral fraction 0/D”. This mineral fraction 0/D can be separated into two particle sizes: the mineral fraction 0/d and the mineral fraction d/D.

The finest elements (the mineral fraction 0/d) will be those in the range between 0 and a maximum diameter that can be set between 2 and 6 mm (from 0/2 to 0/6), advantageously between 2 and 4 mm. The other elements (minimum diameter greater than 2, 3, 4, 5 or 6 mm; and approximately up to 31.5 mm) constitute the mineral fraction d/D.

### Compound of Formula (I)

The compounds useful within the scope of the present invention are compounds of formula (I):

R¹—O—C(O)—R² (I)

wherein:
R¹ is a linear or branched C₁-C₆ alkyl group, and
R² is a linear or branched hydrocarbon chain comprising from 2 to 13 carbon atoms and one or more unsaturations, said unsaturation(s) being carbon-carbon (C═C) double bond(s).

In particular, the compounds useful within the scope of the present invention are compounds of formula (I):

R¹—O—C(O)—R² (I)

wherein:
R¹ is a linear or branched C₁-C₆ alkyl group, and
R² is a linear or branched hydrocarbon chain comprising from 5 to 13 carbon atoms and one or more unsaturations, said unsaturation(s) being carbon-carbon (C═C) double bond(s).

The compounds of formula (I) preferably have a weight molecular mass ranging from 140 g/mol to 270 g/mol. The molecular mass may, for example, be greater than or equal to 150 g/mol, in particular greater than or equal to 160 g/mol or even 170 g/mol. On the other hand, the molecular mass remains typically less than 260 g/mol, for example less than or equal to 250 g/mol.

The total number of carbon atoms of the compounds of formula (I) preferably varies from 5 to 17. According to one embodiment, the total number of carbon atoms is greater than or equal to 6, or even greater than or equal to 7, for example greater than or equal to 8. Besides, it is generally preferred that the total number of carbon atoms is less than or equal to 16, for example less than or equal to 15. The total number of carbon atoms may for example be between 10 and 16, for example between 11 and 15 or between 11 and 14.

In some embodiments, R¹ is a methyl, ethyl, n-propyl, isopropyl, n-butyl, isobutyl, tert-butyl, n-pentyl or isopentyl group, preferably a C₁-C₃ alkyl group, for example a methyl, ethyl or isopropyl group, in particular a methyl group.

In some embodiments, R² is a linear or branched hydrocarbon chain comprising from 5 to 13, preferably from 8 to 13, more preferably from 9 to 13 carbon atoms, carrying at least one carbon-carbon double bond.

Preferably, R² is a hydrocarbon chain as defined above comprising one or two carbon-carbon double bonds.

Preferably, R² is a linear or branched, preferably linear, monounsaturated hydrocarbon chain, that is, a hydrocarbon chain comprising a single carbon-carbon (C═C) double bond. Preferably, said carbon-carbon (C═C) double bond in R² is located at the end of the hydrocarbon chain, that is, in position n−1, n−2 or n−3, preferably n−1 or n−2, in particular n−1, n being the number of carbon of R², it being understood that position 1 refers to the carbon making the bond with the C═O function.

In certain embodiments, R¹ is a C₁-C₃ alkyl group as described above, in particular a methyl group, and R² is a linear or branched, preferably linear, unsaturated hydrocarbon chain comprising a single carbon-carbon (C═C) double bond. Preferably, in these embodiments, said carbon-carbon (C═C) double bond in R² is located at the end of the hydrocarbon chain, that is, in position n−1, n−2 or n−3, preferably n−1 or n−3, in particular n−1, n being the number of carbon of R², it being understood that position 1 refers to the carbon making the bond with the C═O function. In these embodiments, R² is a hydrocarbon chain comprising from 5 to 13, preferably from 8 to 13, more preferably from 9 to 13 carbon atoms.

As an example of a compound of formula (I), mention can be made especially of methyl 9-decenoate, methyl 9-dodecenoate, methyl 10-undecenoate, ethyl 10-undecenoate, n-propyl 10-undecenoate, isopropyl 10-undecenoate, ethyl 9-decenoate, n-propyl 9-decenoate, isopropyl 9-decenoate, ethyl 9-dodecenoate, n-propyl 9-decenoate, isopropyl 9-decenoate and methyl 9,12-tridecadienoate.

In particular, the compound of formula (I) corresponds to the following compounds:
methyl 9-decenoate of formula

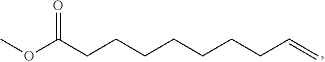

methyl 9-dodecenoate of formula

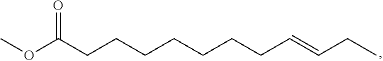

methyl 10-undecenoate of formula

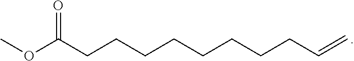

The compounds of formula (I) are commercially available or can be prepared according to methods known those skilled in the art.

Thus, according to a particular embodiment, the compounds of formula (I) according to the invention can be obtained by metathesis reaction of a glyceride comprising at least one unsaturation in the presence of an olefin and a ruthenium metathesis catalyst to lead to the desired ester according to the method described in U.S. Pat. No. 8,569,560.

According to a particular embodiment, said glyceride is especially selected from vegetable oils, in particular soybean oil, olive oil, rapeseed oil, sunflower oil, safflower oil, corn oil, cottonseed oil, palm oil, sesame oil, Jatropha oil, castor oil, grape seed oil, peanut oil, and mixtures thereof. Preferably, it is rapeseed oil, palm oil, Jatropha oil or soybean oil.

Said olefin is preferably selected from α-olefins, especially having a number of carbon atoms less than or equal to 7. In particular, said olefin includes ethylene, 1-propene, 1-butene, 1-pentene, 1-hexene and 1-heptene.

The metathesis catalyst used is especially a Grubbs-Hoveyda type catalyst as described in U.S. Pat. No. 8,569,560.

Preferably, methyl 9-decenoate and methyl 9-dodecenoate are obtained by metathesis reaction from a vegetable oil of triglyceride nature as described above, with an α-olefin, in particular 1-butene, and a metathesis catalyst.

According to another particular embodiment, the compounds of formula (I) according to the invention can be obtained by very high temperature pyrolysis of castor oil esters according to the method described in application WO 2013/079888 on page 11, lines 10-12 and 26-32 and page 12, lines 22-28, also known as steam cracking.

This pyrolysis method can especially be used for the synthesis of methyl 10-undecenoate by pyrolysis of castor oil methyl ester.

As previously indicated, the compound of formula (I) may be used alone or in admixture with one or more other compounds of formula (I) and/or one or more other fluxing agents which may be fluxing agents commonly used in the technical field or as described in document FR3068702.

Thus, in some embodiments, the compounds of formula (I) may be used in admixture with other compounds known as fluxing agents such as vegetable fluxing agents such as for example Oleoflux®, or mineral fluxing agents such as for example Greenflux® SD, Greenflux® 2000 or Varsol 120.

In some embodiments, the compounds of formula (I) may be used in admixture with one or more compounds of formula (II) described in document FR 3 068 702:

R³—C(O)—O—R⁴ (II):

where each of R³ and R⁴, which may be identical or different, is a hydrocarbon chain not comprising unsaturated covalent bonds, which is linear or branched, optionally interrupted by one or more oxygen atoms, and possibly carrying one or more hydroxyl functions.

The compound of formula (II) may advantageously be introduced in admixture with the compound of formula (I), according to one and/or other of the aforementioned alternatives 1, 2 and/or 3 or during step (E0). More generally, a compound known as a fluxing agent as described above and/or one or more compounds of formula (II) may be added to the binder before and/or during and/or after (and preferably before and/or during) contacting the solid particles with the binder, independently of the time of introduction of the compound of formula (I). According to a particular embodiment, at least part of the compounds of formula (I) and at least part of the compounds of formula (II) are present simultaneously in the binder, preferably at least during part of the time the binder is in contact with the solid particles.

The mass ratio of compound of formula (I) to compound of formula (II) is advantageously greater than or equal to 1, more advantageously between 1 and 5, even more advantageously between 1 and 3.

In certain embodiments, the mass ratio of compound of formula (I) to compound of formula (II) is greater than 5, or even greater than 10, or even greater than 15.

As examples of compounds of formula (II), mention can be made of methyl laurate, ethyl laurate, isopropyl laurate, the mixture of methyl laurate and methyl myristate, methyl cocoate, ethyl cocoate, isopropyl cocoate, methyl myristate, ethyl myristate, isopropyl myristate, Texanol® or 2-ethyl hexyl acetate.

In some embodiments, the compounds of formula (I) useful according to the invention are used as a mixture not comprising a compound of formula (II).

### Bituminous Products

A “bituminous product” refers to a product comprising a hydrocarbon binder and solid particles, in particular mineral solid particles. In particular, mention can be made of cold cast bituminous materials (CCBMs), chip seals, emulsion mixes, storable mixes, hot mixes, warm mixes with controlled workability, which are described in more detail below. The bituminous products may contain significant contents (ranging from 0% to 100% by weight, advantageously from 20% to 50% by weight, based on the total weight) of recycled products (asphalt product aggregates, mix aggregates).

The bituminous products are prepared according to methods known in the technical field, the difference being the use of a compound of formula (I) as described above.

Chip Seal

A chip seal, for the purposes of the present description, refers to a layer consisting of superimposed layers of a hydrocarbon binder and solid particles, in particular mineral solid particles. It is typically obtained by spraying a hydrocarbon binder and then spreading solid mineral particles on this binder, in one or more layers. The whole is then compacted. A chip seal requires not only a binder that is sufficiently fluid to be sprayed, but also a binder that allows a good attachment of the solid mineral particles to the substrate.

Thus, the fluxing agent added to the binder has to allow it to soften without being detrimental to the wetting of the solid mineral particles by the binder. Furthermore, the fluxing agent has to soften the binder when it is sprayed, but once sprayed, the binder has to harden quickly to also meet the criterion of cohesion rise. If the binder does not property wet the solid mineral particles, the adhesion of the binder to these particles will be unsatisfactory or unacceptable.

The binder-mineral solid particle affinity is determined by the wettability of the mineral solid particles by the binder, which is assessed by means of the binder-aggregate adhesiveness test by cohesion measurement Vialit (NF EN 12272-3, 2003-07-01).

It was found that the compound of formula (I) enables the hydrocarbon binder to be effectively fluxed, with a satisfactory cohesion rise, without being detrimental to the binder-mineral solid particles affinity.

The compound of formula (I) is advantageously added in its entirety to the hydrocarbon binder and then the resulting composition comprising the hydrocarbon binder and the compound of formula (I) is sprayed onto the mineral solid particles before complete evaporation of the compound of formula (I) out of the composition. In other words, said compound of formula (I) is still present at least in part when the fluxed binder and the mineral solid particles are contacted, preferably in a sufficient amount in the composition to allow good adhesion of the binder to the mineral solid particles.

The solid mineral particles used in a dressing advantageously belong to the following granular classes (d/D): 4/6.3, 6.3/10, 10/14.

The total content of hydrocarbon binder in a dressing will be adapted according to the structure of the dressing (single or two-layer, type of gravelling), the nature of the binder and the size of the solid mineral particles, in particular the aggregates, by following for example the recommendations of the document “Enduits superficiels d'usure—Guide technique, May 1995”.

The hydrocarbon binder used for the manufacture of a dressing can be bitumen, pure or modified by polymers, as described above.

The hydrocarbon binder used in the manufacture of a dressing may be in the form of anhydrous binder or in the form of emulsion binder.

In one embodiment, the hydrocarbon binder is used in the form of an anhydrous binder in the manufacture of the dressing.

In this embodiment, the hydrocarbon binder advantageously comprises, based on the total weight of the hydrocarbon binder, from 3% to 18% by weight of fluxing agent, said fluxing agent referring to a compound of formula (I) or a mixture of compounds of formula (I), optionally in admixture with other vegetable or mineral fluxing agents as described above.

In this embodiment, the dressing is advantageously implemented at a temperature less than or equal to 200° C., for example ranging from 120° C. to 180° C. or ranging from 130° C. to 160° C.

In another embodiment, the hydrocarbon binder is an emulsion binder.

In this embodiment, the hydrocarbon binder advantageously comprises, based on the total weight of the hydrocarbon binder, 0.1 to 10% by weight of said compound of formula (I) or of the mixture of compounds of formula (I), more advantageously 0.5 to 8% by weight, even more advantageously 1 to 6% by weight.

In this embodiment, the dressing is advantageously implemented at a temperature less than or equal to 40° C., for example ranging from 5° C. to 40° C. or ranging from 15° C. to 35° C.

Emulsion Bituminous Concrete (EBC)

Emulsion bituminous concretes, also known as emulsion mixes, are hydrocarbon mixes cold produced from a mixture of solid particles, in particular solid mineral particles including aggregates, a hydrocarbon emulsion binder, typically bitumen (modified or not) and additives. The aggregates can be used without prior drying and heating or can undergo partial hot pre-lacquering. It may sometimes be necessary to reheat the resulting mix after it has been manufactured, during its implementation.

This so-called “cold” technique has the important environmental advantage of not producing smoke emissions, which reduces nuisance for workers and residents.

However, the quality of the coating can be poor, with the observation of a raveling phenomenon: poor distribution of the bitumen film over the whole granular fraction, all the more so as the fluxing or liquefying agent content is high. The more fines the granular fraction contains, the worse the distribution of the binder will be on the granular fraction (mainly on the large elements).

To overcome or limit these problems of loss of compactability and poor distribution of the bitumen film over the whole granular fraction, the mixing step of the granular fractions and the binder, possibly the fluxing agent, can be sequenced. These sequenced methods involve more steps and are therefore less economical.

It has now been found that the compound of formula (I) enables emulsion bituminous concrete to be efficiently fluxed. The compound of formula (I) also helps compaction. The invention may also dispense with the implementation of sequencing and/or reheating methods.

The compound of formula (I) is advantageously added to the hydrocarbon binder according to one and/or other of the 3 alternatives described above, and thus before and/or during and/or after contacting the binder and the solid particles. The compound of formula (I) is introduced at the latest before the emulsion bituminous concrete is implemented and is present at least in part in the composition comprising the binder and the solid particles to allow good adhesion.

In one embodiment adapted to bituminous concretes, the compound of formula (I) is introduced into the emulsion binder, then said binder is contacted with solid particles (alternative 1).

In another embodiment adapted to bituminous concretes, the compound of formula (I) is introduced at least partly at the same time as the solid particles into the emulsion binder (alternative 2).

In another embodiment adapted to bituminous concretes, some or all of the compound of formula (I) is introduced into a premix based on emulsion binder and solid particles (alternative 3). The resulting composition still comprises a sufficient amount of the compound of formula (I) for the implementation of the emulsion bituminous concrete.

The solid particles, in particular the mineral solid particles (for example natural mineral solid particles or mix aggregates), for emulsion bituminous concretes advantageously comprise:
elements smaller than 0.063 mm (filler or fines)
sand, the elements of which are between 0.063 mm and 2 mm;
pea gravels, the elements of which have dimensions ranging from 2 mm to 6, 10 or 14 mm.

The hydrocarbon binder used for the synthesis of emulsion bituminous concrete is in the form of emulsion binder. The total content of hydrocarbon binder in said emulsion is typically 2 to 8 ppc (weight part percent), advantageously 3 to 7 ppc, more advantageously 3.5 to 5.5 ppc, based on the weight of the solid particles. This binder content corresponds to the amount of binder introduced as such (feed binder) plus any amount of binder recovered from the mix aggregates that may form part of the solid mineral fraction.

The hydrocarbon binder in an emulsion used for making emulsion bituminous concrete advantageously comprises, based on the total weight of the hydrocarbon binder, 1 to 25% by weight of said compound of formula (I) or of the mixture of compounds of formula (I), more advantageously 2 to 15% by weight, even more advantageously 2 to 10% by weight, even more advantageously 3 to 10% by weight. These contents are calculated for the case where the compound of formula (I) is actually added to the binder before contacting with solid particles or for the case where it is added to the composition comprising the binder and the solid particles.

Emulsion bituminous concretes can be used for the manufacture of storable mixes.

In this embodiment, the hydrocarbon binder advantageously comprises, based on the total weight of the hydrocarbon binder, 10 to 30% by weight of said compound of formula (I) or of the mixture of compounds of formula (I), more advantageously 15 to 25% by weight, still more advantageously 17 to 22% by weight.

Cold Cast Bituminous Materials (CCBM)

Cold cast bituminous materials are surface course mixes consisting of solid particles, such as mineral solids, for example aggregates, not dried, coated with bitumen emulsion and cast in place continuously by means of specific equipment.

Once the emulsion has been implemented and broken, this cold cast surfacing, which is very thin (generally 6 to 13 mm thick per layer), has to achieve its final consistency (cohesion) very quickly. The two essential parameters governing the formulation, manufacture and implementation of cold cast bituminous materials are:
the workability of the mixture of solid particles (aggregates)/emulsion: optimisation of the proportions of the various constituents (water, additives, emulsion formulation) to obtain a sufficient implementation time and thus allow the mixing of the solid particles (aggregates) with the emulsion in the mixer.
The kinetics of “cohesion rise”: the cold cast bituminous material, after application on the pavement, has to acquire a cohesion rise as quickly as possible for opening to traffic. For curing temperatures ranging from 7 to 40° C., a time of 30 minutes is considered relevant for the skilled person to meet the most stringent specifications.

It has been found that compounds of formula (I) enable cold cast bituminous materials to be effectively fluxed. In particular, the compounds of formula (I) allow the kinetics of cohesion rise of the cold cast bituminous material to be improved.

For a cold cast bituminous material, the initially separated bitumen droplets give the system fluidity and easy placement with the specific machines for cold cast bituminous materials. The system is then viscous. The characteristic time during which this state persists is called the workability time. In a second phase, the bitumen droplets gradually coalesce. When all the bitumen droplets are grouped together, the emulsion is considered to have broken (breakage time). The system is then viscoelastic. The system then tends to contract so as to reduce the contact surface between the water and the bitumen (cohesion time). This process follows a kinetic which will depend on the electrostatic repulsions between droplets and therefore on the nature of the bitumen and the emulsifier. The kinetics of the coalescence reaction between the bitumen droplets will condition the speed of the cohesion rise of the cold cast bituminous material, which may or may not result in the material being sensitive to early curing conditions.

The compounds of formula (I) advantageously facilitate the coalescence of the bitumen droplets.

In one embodiment adapted to cold cast bituminous materials, the compound of formula (I) is introduced into the emulsion binder, then said binder is contacted with solid particles, in particular aggregates (alternative 1).

In a first alternative of the preceding embodiment, the compound of formula (I) is introduced into the binder and then the binder is emulsified in a continuous aqueous phase.

In a second alternative of the preceding embodiment, the compound of formula (I) is introduced into the binder already in emulsion.

In another embodiment adapted to cold cast bituminous materials, the compound of formula (I) is added at the same time as the solid particles (aggregates) to the emulsion hydrocarbon binder (alternative 2). It is possible to pre-mix the compound of formula (I) and the solid particles.

In another embodiment, the two previous embodiments are combined and thus:
a part of the compound of formula (I) is introduced into the emulsion binder, according to the first or second alternative, and then said binder is contacted with solid particles (aggregates) and
another part of the compound of formula (I) is added at the same time as the solid particles (aggregates) to the emulsion hydrocarbon binder and the already introduced part of the compound of formula (I).

In another embodiment adapted to cold cast bituminous materials, some or all of the compound of formula (I) is introduced into a premix based on emulsion binder and solid particles (aggregates) (alternative 3), prior to breaking the emulsion.

The solid particles (for example natural mineral solid particles or mix aggregates) used for cold cast bituminous materials advantageously comprise:
elements smaller than 0.063 mm (filler or fines)
sand, the elements of which are between 0.063 mm and 2 mm;
pea gravels, the elements of which have dimensions ranging from 2 mm to 6, 10 or 14 mm.

The hydrocarbon binder used for the manufacture of cold cast bituminous materials is in the form of an emulsion binder.

In this emulsion, the binder content advantageously varies from 50 to 75% by weight of binder, based on the total weight of the emulsion, more advantageously from 55 to 70% by weight, still more advantageously from 60 to 65% by weight.

The hydrocarbon binder adapted to cold cast bituminous materials advantageously comprises, based on the total weight of the hydrocarbon binder, 0.1 to 6% by weight of said compound of formula (I) or of the mixture of compounds of formula (I), more advantageously 0.1 to 3% by weight of said compound of formula (I) or of the mixture of compounds of formula (I). In an alternative, the hydrocarbon binder comprises less than 2% by weight of said compound of formula (I) or of the mixture of compounds of formula (I), advantageously less than 1.5% by weight, even more advantageously 0.1 to 1% by weight of said compound of formula (I) or of the mixture of compounds of formula (I)

Hot or Warm Hydrocarbon Mixes

Hot hydrocarbon mixes are obtained by hot mixing solid particles, for example aggregates, and a binder. This binder can be a pure or modified bitumen (for example addition of polymer(s), fluxing agents of petroleum or vegetable origin), a pure or modified vegetable binder or a synthetic binder of petroleum origin. The solid particles (aggregates) are heated, usually to a temperature above 100° C.

Warm hydrocarbon mixes are mixes implemented at temperatures approximately 30-50° C. lower than those used for hot hydrocarbon mixes.

It has been found that compounds of formula (I) enable hot or warm hydrocarbon mixes to be effectively fluxed, with satisfactory cohesion rise, and good wettability of solid particles, for example mineral solids.

The compound of formula (I) is advantageously added to the hydrocarbon binder according to one and/or other of the 3 alternatives described above, and thus before and/or during and/or after contacting the binder and the solid particles. The compound of formula (I) is introduced at the latest before implementing the hot or warm hydrocarbon mixes, and is present at least partly in the composition comprising the binder and the solid particles to allow good adhesion.

In an adapted embodiment, the compound of formula (I) is introduced into the binder and then said binder is contacted with solid particles (alternative 1).

The solid particles are as defined above (for example natural mineral solid particles or mix aggregates) and advantageously comprise:
elements smaller than 0.063 mm (filler or fines)
sand, the elements of which are between 0.063 mm and 2 mm;
pea gravels, the elements of which have dimensions ranging from 2 mm to 6, 10 or 14 mm.

The hydrocarbon binder is in anhydrous form.

The total content of hydrocarbon binder is 3 to 7 ppc (part percent by weight), advantageously 3.5 to 6 ppc based on the weight of the solid particles.

This binder content corresponds to the amount of binder introduced as such (feed binder) plus the amount of binder, if any, recovered from the mix aggregates forming part of the solid fraction.

For hot or warm hydrocarbon mixes, the hydrocarbon binder advantageously comprises, based on the total weight of the hydrocarbon binder, 1 to 30% by weight of said compound of formula (I) or of the mixture of compounds of formula (I).

The fluxing agent content is adjusted according to the time between manufacture and implementation.

When the hot or warm hydrocarbon mixes are used quickly after manufacture, for example for the manufacture of wearing courses, the hydrocarbon binder advantageously comprises, based on the total weight of the hydrocarbon binder, 0.1 to 6% by weight of said compound of formula (I) or of the mixture of compounds of formula (I).

These hot or warm hydrocarbon mixes can be used for the manufacture of storable mixes.

In this embodiment, the hydrocarbon binder advantageously comprises, based on the total weight of the hydrocarbon binder, 15 to 30% by weight of said compound of formula (I) or of the mixture of compounds of formula (I), more advantageously 15 to 25% by weight, even more advantageously 17 to 22% by weight.

### EXAMPLES

### Description of the Test Methods:

Stabilisation of Fluxed Binders:

Anhydrous binders: This is a method for obtaining a thin layer of binder. Stabilisation is carried out in accordance with NF EN 13074 1.2 standard (April 2011) by leaving the fluxed bitumen for 24 hours at laboratory temperature, then transferring it to a ventilated oven for 24 hours at 50° C., and finally, 24 hours at 80° C. to allow the fluxing agent to evaporate.

Pseudo-Viscosity STV:

For anhydrous binders: This is a method for measuring the viscosity of a fluxed bitumen by determining the flow time of the product at 40° C. or 50° C. through a 10 mm port. The pseudo-viscosity STV is measured in accordance with NF EN 12848-2 standard (April 2011).
Penetrability: Penetrability corresponds to the consistency expressed as the depth, in tenths of a millimetre, corresponding to the vertical penetration of a reference needle into a test sample of the material, under prescribed conditions of temperature, load and duration of load application. The penetrability test is performed according to EN 1426 standard (June 2007). In the examples, the measurements were carried out at 25° C., for a load of 100 g and a duration of 5 s. Penetrability can be measured from a fluxed bitumen, a stabilised binder obtained from a fluxed bitumen or a stabilised binder obtained from a bitumen emulsion.
Ball-ring temperature: This is the temperature at which the binder achieves a specified consistency under the reference conditions of the test. Two horizontal discs of bitumen, moulded in brass shouldered rings, are heated in an agitated liquid bath (water) with a controlled rate of temperature rise (5° C./min, initial bath temperature (5±1) ° C.), while each supports a steel ball. The softening point noted has to correspond to the average of the temperatures at which the two discs soften sufficiently to allow each ball, wrapped in bituminous binder, to drop from a height of (25.0±0.4) mm. The measurement is carried out in accordance with NF EN 1427 standard (June 2007). The ball-ring temperature can be measured from a fluxed bitumen, a stabilised binder obtained from a fluxed bitumen or a stabilised binder obtained from a bitumen emulsion.
Mass loss after stabilisation: The mass loss after stabilisation is measured as the difference in mass between the binder deposited at the beginning of the stabilisation procedure and the mass of binder actually measured after the stabilisation step (NF EN 13074 1.2 standard, April 2011)
Evaporation curves (thermobalance): This is a measurement of the mass loss of a fluxed bitumen as a function of time at a fixed temperature of 50 or 85° C. The test is carried out using a thermobalance and enables the evaporation kinetics of a fluxing agent to be evaluated.
Adhesiveness: This is a method for determining the binder-aggregate adhesiveness and the influence of additives on the characteristics of this adhesiveness (NF EN 12272-3 Standard July 2003). The required amount of binder is heated to the spreading temperature and then applied uniformly to a steel plate. The test is carried out at (5±1) ° C. 100 graded pea gravels are distributed on the binder and rolled. The plate thus prepared is turned over and placed on a three-pointed support. A steel ball is dropped onto the plate from a height of 500 mm, three times in 10 s.
The compactibility of emulsion bituminous concrete is determined by the gyratory shear press compaction test (NF P 98-252—June 1999): Compaction is obtained by kneading under a low static compression of a cylinder of hydrocarbon mixture contained in a mould limited by pellets and maintained at a fixed temperature. Compaction is obtained by a combination of gyratory shear and an axial resultant force applied by a mechanical head. This method makes it possible to determine the change in the percentage of voids in the specimen as a function of the number of gyrations.
EBC modulus (NF EN 12697-26 Annex C—June 2012): Prior to the measurement of the modulus of rigidity, emulsion bituminous concrete specimens are prepared by press compaction to a value of voids content equivalent to the voids content measured according to the Duriez test modality 2 by removing 2%. The specimens are then cured at 35° C. and 20% hygrometry for 14 days. The modulus of rigidity is then measured at 14 days by indirect traction on cylindrical specimens conditioned at 10° C. (IT-CY). The rise time, measured from the start of the loading pulse and which is the time taken for the load to be applied from the initial contact loading to the maximum value, should be 124±4 ms.
EBC Workability: This test is carried out 4 hours after the EBC has been manufactured with a NYNAS Workability Meter. It consists in measuring the force necessary for a mobile arm to move at a constant speed approximately 10 kg of a mix contained in a mould designed for this purpose. The workability of the mix is sufficient if the force is less than approximately 200 Newton.
Duriez test, modality 1 (NF P 98-251-4, DATE): The purpose of this test method is to determine, for two compaction modalities, the percentage of voids and the water resistance, at 18° C., of a cold bitumen emulsion hydrocarbon mix from the ratio of the compressive strengths with and without immersion of the specimens. According to modality 1, the specimens are made with a load of 60 kN per specimen.

### Description of the Compounds Tested:

The following compounds were tested:

R1 Petroleum fluxing agent—Greenflux® SD marketed by TOTAL

R2 Methyl Laurate (Radia 7118)
Closed cup flash point: 140° C.
Boiling point: 262° C. at 766 mmHg
Molecular mass: 212 g/mol

R3 Sunflower methyl ester (Oleoflux® marketed by Oleoroute)

R4 Petroleum fluxing agent—Greenflux® 2000 marketed by TOTAL

F1 Methyl 9-decenoate (marketed by Elevance Renewable Sciences)
Closed cup flash point: 107° C.
Boiling point: 235° C. at 766 mmHg
Molecular mass: 184 g/mol

F2 Methyl 9-dodecenoate (marketed by Elevance Renewable Sciences)
Closed Cup Flash Point: 127° C.
Boiling point: 267° C. at 766 mmHg
Molecular mass: 210 g/mol

F3 mixes 40% of F1 and 60% of F2

### Example 1: Fluxed Binders for Chip Seals

In order to obtain the fluxing curves of the different compounds, the following binders were prepared.

TABLE 1

| | | | Fluxing agent content | |
|---|---|---|---|---|
| Bitumen | Bitumen | Fluxing | (% by weight based on | Mixture |
| Supplier | Grade | Agent | the weight of the binder) | (Binder) |
| ESSO | 70/100 | — | 0 | T0 |
| | | R1 | 6.7 | C1 |
| | | | 6.2 | C2 |
| | | R2 | 6 | C3 |
| | | | 5.5 | C4 |
| | | | 5 | C5 |
| | | R3 | 6.2 | C6 |
| | | F1 | 8 | L1 |
| | | | 6 | L2 |
| | | | 5 | L3 |
| | | F2 | 6 | L4 |
| | | | 5.5 | L5 |
| | | | 5 | L6 |
| | | F3 | 6 | L7 |
| | | | 5.5 | L8 |
| | | | 5 | L9 |

Binder T0 is an unfluxed binder, which serves as a control to compare the performance of the binder according to the invention with the binder without the addition of the compound according to the invention. Binders C1 and C2 are binders fluxed with a volatile petroleum flux, which serve as comparative examples. Binders C3, C4 and C5 are binders fluxed with a volatile short-chain saturated monoester fluxing agent (methyl laurate), which serve as comparative examples. Binder C6 is a fluxed binder with a long chain unsaturated monoester vegetable fluxing agent (sunflower oil methyl ester), which serves as a comparative example. Binders L1 to L9 are binders according to the invention.

The properties of the binders according to the pseudo-viscosity STV test at 40° C. with a 10 mm port (NF EN 12848-2) are reported in the following table.

TABLE 2

| | Fluxing agent content (% | Pseudo-viscosity |
|---|---|---|
| Mixture | by weight based on the | STV 40° C., 10 mm, |
| (Binder) | weight of the binder) | s (NF EN 12846-2) |
| C1 | 6.7 | 549 |
| C2 | 6.2 | 598 |
| C3 | 6 | 388 |
| C4 | 5.5 | 498 |
| C5 | 5 | 642 |
| L1 | 8 | 124 |
| L2 | 6 | 308 |
| L3 | 5 | 418 |
| L4 | 6 | 364 |
| L5 | 5.5 | 447 |
| L6 | 5 | 617 |
| L7 | 6 | 332 |
| L8 | 5.5 | 411 |
| L9 | 5 | 555 |

The measurement of the pseudo-viscosity STV at 40° C. with a 10 mm port of the fluxed bitumens was carried out according to the protocol described in standard NF EN 12846-2 (April 2011).

It is observed that the binders according to the invention enable superior results to be obtained in terms of fluxing (seen through the viscosity) compared to the reference with the petroleum flux. It can also be seen that the binders according to the invention achieve superior results in terms of fluxing compared to the reference with the methyl laurate (saturated monoester) flux.

These results show that the monounsaturated nature of the fluxing agents of the invention makes it possible to obtain superior fluxing compared to equivalent fluxing agents of a saturated nature.

The evaporation profiles (flux mass loss versus time) for binders C1, C4, C6, L3, L5 and L8 without stabilisation were measured.

The results are reported in the following table.

TABLE 3

Binder

| | | | | | | |
|---|---|---|---|---|---|---|
| time | C1 | C4 | L3 | L5 | L8 | C6 |

| | |
|---|---|
| (min) | Mass loss (% flux) |

| | | | | | | |
|---|---|---|---|---|---|---|
| 0 | 0.0 | 0 | 0 | 0.0 | 0.0 | 0 |
| 1 | 3.6 | 6.2 | 3.4 | 2.9 | 2.5 | 1.5 |
| 2 | 3.6 | 6.2 | 4 | 3.5 | 3.1 | 1.8 |
| 5 | 5.7 | 7.5 | 6.8 | 4.5 | 5.6 | 2.1 |
| 10 | 8.8 | 9.8 | 12 | 6.7 | 10.4 | 2.6 |
| 20 | 14.0 | 14.7 | 19 | 10.2 | 17.6 | 2.6 |
| 30 | 17.2 | 20.2 | 24.2 | 14.2 | 23.3 | 2.9 |
| 60 | 26.6 | 35.1 | 36.8 | 22.7 | 35.6 | 3.2 |
| 90 | 34.3 | 47.3 | 47.6 | 31.1 | 44.9 | 5.5 |
| 120 | 41.2 | 57.8 | 56.8 | 39.5 | 53.3 | 7.6 |
| 180 | 52.1 | 73.6 | 71.2 | 53.3 | 66.2 | 10.2 |
| 240 | 60.9 | 83.5 | 81 | 64.0 | 74.9 | 11.6 |

First of all, it is observed that in binders C1, C4, L3, L5 and L8, the fluxing agent has volatilised but not in binder C6 for which the mass loss at 85° C. is very low (11.6% of the fluxing agent evaporated) after 240 minutes of isotherm. It is also observed that the fluxing agents of binders L3, L5 and L8 evaporate more than the fluxing agent of the reference binder C1.

The following binders were then prepared.

TABLE 4

| | | | Fluxing agent | | | |
|---|---|---|---|---|---|---|
| | | | | Fluxing | Adhesion Dope | |
| | | | | agent content | | Flux content |
| | Bitumen | | | (wt. % based on | | (wt. % based on |
| | Supplier | Grade | Name | binder weight) | Name | binder weight) |
| T0 | ESSO | 70/100 | — | 0 | — | 0 |
| C7 | | | R1 (1) | 6.7 | Impact | 0.3 |
| C8 | | | R2 (2) | 5.5 | 9000 (3) | 0.3 |
| L10 | | | F1 | 5 | | 0.3 |
| L11 | | | F2 | 5.5 | | 0.3 |
| L12 | | | F3 | 5.5 | | 0.3 |

(1) Greenflux ® SD marketed by TOTAL
(2) Radia 7118 marketed by OLEON
(3) tallol fatty amides, N-[(dimethylamino)-3propyl] marketed by INGEVITY

Binder T0 is a non-fluxed binder, which serves as a control to compare the performance of the binder according to the invention with the binder without the addition of the compound according to the invention. Binder C7 is a binder fluxed with a volatile petroleum flux, which serves as a comparative example. Binder C8 is a binder fluxed with a volatile saturated monoester fluxing agent (methyl laurate), which serves as a comparative example. Binders L10, L11 and L12 are binders according to the invention. The properties of the binders after stabilisation and the results of the adhesiveness of the binders to the aggregates are reported in the following table.

TABLE 5

| | | | | | |
|---|---|---|---|---|---|
| T0 | C7 | C8 | L10 | L11 | L12 |

Before stabilisation

| | | | | | | |
|---|---|---|---|---|---|---|
| Penetrability at 25° C., 1/10 mm | 70 | — | — | — | — | — |
| Ring ball temperature, ° C. | 47.4 | — | — | — | — | — |

After stabilisation (NF EN 13074-1&2)

| | | | | | | |
|---|---|---|---|---|---|---|
| Mass loss after stabilisation (% | — | 43.3 | 58.2 | 74 | 72.7 | 72.7 |
| fluxing agent evaporated) | | | | | | |
| Penetrability at 25° C., 1/10 mm | — | 138 | 110 | 78 | 106 | 91 |
| Ball-ring temperature, ° C. | — | 40.6 | 43.4 | 45.6 | 42.8 | 44.8 |

Adhesiveness to Vialit 5° C. + Viadop PX10051 40 g/m²
Aggregate 6/10 La Meilleraie - dry washed

| | | | | | | |
|---|---|---|---|---|---|---|
| Dropped unstained | — | 1 | 0 | 0 | 1 | — |
| Dropped and stained | — | 37 | 21 | 47 | 18 | — |
| Bonded to the plate | — | 62 | 79 | 53 | 81 | — |

The stabilisation of fluxed bitumens was carried out according to the protocol described in NF EN 13074 1.2 standard (April 2011). All the tests were carried out according to the protocols described in the standards mentioned in references and explained above.

It is observed that the binders according to the invention enable satisfactory results to be obtained in terms of adhesiveness.

Furthermore, the binders according to the invention recover their properties before fluxing, seen through the penetrability and the ball-ring temperature. The binders according to the invention (L10, L11 and L12) have, after stabilisation, lower penetrability values and higher ball-ring temperature values than those measured with the reference binder C7.

These results show that the binders according to the invention make it possible to obtain hard chip seals in the short term, which allows good resistance of the dressing in the early stages of life and during the first heat waves.

### Example 2: Emulsion Bituminous Concretes

Emulsion bituminous concretes are defined by the French NF P98-139 standard (December 2016).

Emulsion bituminous concretes according to the following formulas for a Type 2 M EBC were prepared:

TABLE 6

| | EBC I2 | EBC I3 | EBC C1 | EBC C2 |
|---|---|---|---|---|
| Solid mineral fraction | 0/2 Dussac + 2/6 Dussac + 6/10 Dussac | | | |
| Feed emulsion | 7.54 ppc | 7.54 ppc | 7.23 ppc | 7.54 ppc |
| Fluxing agent-content | 0.2 ppc | | | |
| Fluxing agent-nature | F2 | F3 | R3 | R2 |
| Theoretical residual | 4.67 | 4.67 | 4.68 | 4.67 |
| anhydrous binder | | | | |
| content | | | | |

In these two tables:

“ppc” means “parts percent by weight” based on the weight of the solid mineral fraction. The emulsion is a cationic emulsion comprising a 70/100 bitumen as binder. The binder content of the emulsion used is 65% by weight, based on the total weight of the emulsion. The fluxing agent was introduced by spraying at the end of mixing.

The compactibility (PCG), modulus, workability and compressive strength of these emulsion bituminous concretes were evaluated.

The results are reported in the following tables:

TABLE 7

| | PCG % voids as a function of gyrations | | | | | | | | | | | | | |
|---|---|---|---|---|---|---|---|---|---|---|---|---|---|---|
| | 5 | 10 | 15 | 20 | 25 | 30 | 40 | 50 | 60 | 80 | 100 | 120 | 150 | 200 |
| EBC I2 | 24.7 | 22.0 | 20.4 | 19.4 | 18.6 | 18.0 | 17.0 | 16.4 | 15.8 | 15.0 | 14.4 | 13.9 | 13.4 | 12.7 |
| EBC I3 | 24.3 | 22.7 | 20.9 | 19.7 | 18.8 | 18.1 | 17.2 | 16.5 | 16.0 | 15.3 | 14.7 | 14.2 | 13.7 | 13.0 |
| EBC C1 | 25.4 | 22.6 | 21.1 | 20.1 | 19.4 | 18.8 | 18.0 | 17.3 | 16.7 | 16.2 | 15.6 | 15.1 | 14.6 | 13.9 |
| EBC C2 | 24.9 | 24.4 | 22.7 | 20.8 | 19.8 | 19.2 | 18.5 | 18.3 | 17.7 | 16.6 | 15.8 | 16.3 | 15.2 | 14.2 |

The compactibility results demonstrate the ability of the compounds of the invention to slightly improve the compaction of emulsion bituminous concrete and to reduce the void content compared to the same formula with the reference fluxing agents (EBC C1 and EBC C2).

TABLE 8

| | Workability |
|---|---|
| | (N) at 4 hours |
| EBC I2 | 118 |
| EBC I3 | 96 |
| EBC C1 | 113 |
| EBC C2 | 126 |

Compound (I) improves the workability of emulsion bituminous concrete compared to the reference solutions.

TABLE 9

| | Modulus of rigidity (MPa) |
|---|---|
| | 10° C. 124 ms preservation |
| | 14 days at 35° C. 20% RH |
| EBC 12 | 1288 |
| EBC 13 | 1293 |
| EBC C1 | 1227 |
| EBC C2 | 1331 |

Compound (I) allows a consistency increase in emulsion bituminous concrete comparable to the reference formulations EBC C1 and EBC C2.

TABLE 10

| | Compressive strength | | |
|---|---|---|---|
| | Duriez-modality 1 | | |
| | % voids | R (Mpa) | r/R |
| EBC I2 | 10.3 | 2.93 | 0.72 |
| EBC I3 | 10.5 | 2.73 | 0.78 |
| EBC C1 | 10 | 4.32 | 0.7 |
| EBC C2 | 10.2 | 3.17 | 0.74 |

Compound (I) allows the values specified for the Duriez test in NF P98-139 for a EBC Type 2 M to be obtained.

### Example 3: Fluxed Polymer Binders in Emulsion for Chip Seals

The following binders were prepared:

TABLE 11

| | | C9 | L13 | L14 |
|---|---|---|---|---|
| Polymer | Supplier | Eurovia (1) | | |
| bitumen | Grade | Bitumen grade 70/100 comprising 2.6% by | | |
| | | weight, based on the total weight, of linear SBS | | |
| | | polymer, cross-linked by sulphur | | |
| Flux | Name | R1 | F1 | F2 |
| | Content (wt. % | 5.4 | 3.9 | 3.9 |
| | based on weight of | | | |
| | binder) | | | |

(1) This binder has a cohesion greater than or equal to 1.3 J/cm² as measured according to NF EN 13588 standard of November 2017 after stabilisation according to NF EN 13074-1 and 13074-2 standards.

Binder C9 is a fluxed polymer binder, which serves as a comparative example. The binders L13, L14 and L15 are binders according to the invention.

These binders C9, L13, L14 and L15 were emulsified following the same emulsification protocol, with the same surfactant (HCL/amine). Cationic emulsions are manufactured.

The properties of the binder emulsions are reported in the following table:

| | | | |
|---|---|---|---|
| C9 based | L13 based | L14 based | L15 based |
| emulsion | emulsion | emulsion | emulsion |

PSEUDO VISCOSITY: NF EN 12846-1

| | | | | |
|---|---|---|---|---|
| STV 4 mm a 40° C., s | 8 | 8 | 8 | 7 |
| STV 2 mm a 40° C., s | 60 | 55 | 55 | 55 |

HOMOGENEITY by SIEVING: NF EN 1429

| | | | | |
|---|---|---|---|---|
| Oversize at 0.500 mm | 0.01 | 0.02 | 0.01 | 0.05 |
| (%) | | | | |
| Oversize at 0.160 mm | 0.13 | 0.18 | 0.14 | 0.23 |
| (%) | | | | |

LASER GRANULOMETRY (Malvern): MEI

| | | | | |
|---|---|---|---|---|
| Median diameter (pm) | 4.79 | 4.19 | 5.66 | 5.59 |

DYNAMIC VISCOSITY: NF EN 13302

| | | | | |
|---|---|---|---|---|
| Dynamic viscosity at | 56 | 54 | 62 | 50 |
| 40° C. (mPa · s) | | | | |

BREAKING VALUE: NF EN 13075-1

| | | | | |
|---|---|---|---|---|
| Caolin Q92 | 58 | 54 | 44 | 59 |
| Forshammer | 70 | 65 | 53 | 71 |

DECANTATION: NF EN 12847

| | | | | |
|---|---|---|---|---|
| Decantation at 7 days | 1.2 | 3.8 | 2.8 | 3.2 |
| a 25° C. (%) | | | | |

The properties of the emulsions are in accordance with the expected specifications. The properties of the emulsions with binders L13, L14 and L15 are comparable to those observed for the emulsion with binder C9 while the fluxing agent content for binders L13, L14 and L15 is lower. This demonstrates the effectiveness of the fluxing agents of the invention for emulsifying polymer-binders.

For each of these emulsions, the adhesiveness was determined by a water immersion test according to NF EN 13614 standard (June 2011) with 6/10 CREUZEVAL aggregates (200 g washed and dried). The results are reported in the following table:

| | C9 based | L13 based | L14 based | L15 based |
|---|---|---|---|---|
| | emulsion | emulsion | emulsion | emulsion |
| Aggregate | 6/10 Creuzeval washed/dried | | | |
| Mineralogical nature | Eruptive material - rhyolitic rock | | | |
| Aggregate to residual binder | 200/10 | 200/10 | 200/10 | 200/10 |
| mass ratio | | | | |
| Coating | Good | Good | Good | Good |
| Grade (% cover) | 90 | 90 | 90 | 90 |

A satisfactory coating (90% of surface covered after immersion in water) was obtained with 10 g of residual binder for each emulsion.

The emulsions were stabilised according to the protocol described in the introduction (NF EN 13074-1 and NF EN 13074-2). The results are reported in the following table:

| | C9 based | L13 based | L14 based | L15 based | |
|---|---|---|---|---|---|
| | emulsion | emulsion | emulsion | emulsion | Specifications |
| Penetrability at | 64 | 43 | 50 | 50 | <100 |
| 25° C. (1/10 mm) | | | | | |
| Ball-ring | 56 | 59.4 | 59.4 | 58 | ≥50 |
| temperature (° C.) | | | | | |

Properties of the stabilised emulsions show a faster evaporation of the fluxing agents of the invention compared to the reference petroleum flux.

1-10. (canceled)

11. A method for preparing a bituminous product comprising solid particles and a hydrocarbon binder, said method comprising a step of contacting the hydrocarbon binder, the solid particles and at least one compound of formula (I):
R¹—O—C(O)—R² (I)
in which:
R¹ is a linear or branched C₁-C₆ alkyl group, and
R² is a linear or branched hydrocarbon chain comprising from 5 to 13 carbon atoms and one or more unsaturations, said unsaturation(s) being one or more carbon-carbon double bonds.

12. The method of claim 11, wherein R¹ represents a C₁-C₃ alkyl group, in particular a methyl group.

13. The method of claim 11, wherein R² is a hydrocarbon chain comprising from 8 to 13 carbon atoms.

14. The method of claim 11, wherein R² is a hydrocarbon chain comprising a single carbon-carbon double bond, preferably in position n−1, n−2 or n−3, n being the number of carbon atoms of R², it being understood that position 1 refers to the carbon making the bond with the C═O function.

15. The method of claim 11, wherein the compound of formula (I) is in admixture with another fluxing agent, preferably a compound of formula (II):
R³—C(O)—O—R⁴ (II)
in which each of R³ and R⁴, which may be identical or different, is a hydrocarbon chain not comprising unsaturated covalent bonds, which is linear or branched, optionally interrupted by one or more oxygen atoms, and optionally carrying one or more hydroxyl functions.

16. The method of claim 11, wherein the bituminous product is selected from the group consisting of chip seal, emulsion bituminous concrete, cold cast bituminous material, hot mix, warm mix and semi-warm mix.

17. The method of claim 16, wherein the bituminous product is a chip seal, the hydrocarbon binder is an emulsion binder and wherein the compound of formula (I) is used at a content varying from 0.1 to 10% by weight, based on the total weight of the hydrocarbon binder.

18. The method of claim 16, wherein the bituminous product is an emulsion bituminous concrete and wherein the compound of formula (I) is used at a content varying from 1 to 25% by weight, based on the total weight of the hydrocarbon binder.

19. The method of claim 11, wherein the compound of formula (I) is used in admixture with another fluxing agent.

20. The method of claim 19, wherein said other fluxing agent is a compound of formula (II):
R³—C(O)—O—R⁴ (II)
in which each of R³ and R⁴, which may be identical or different, is a hydrocarbon chain not comprising unsaturated covalent bonds, which is linear or branched, optionally interrupted by one or more oxygen atoms, and optionally carrying one or more hydroxyl functions.

21. The method of claim 11, wherein R² is a hydrocarbon chain comprising from 9 to 13 carbon atoms.

22. The method of claim 11, wherein the compound of formula (I) is selected from the group consisting of methyl 9-decenoate, methyl 9-dodecenoate, methyl 10-undecenoate, ethyl 10-undecenoate, n-propyl 10-undecenoate, isopropyl 10-undecenoate, ethyl 9-decenoate, n-propyl 9-decenoate, isopropyl 9-decenoate, ethyl 9-dodecenoate, n-propyl 9-decenoate, isopropyl 9-decenoate and methyl 9,12-tridecadienoate.

23. The method of claim 20, wherein the compound of formula (II) is selected from the group consisting of methyl laurate, ethyl laurate, isopropyl laurate, the mixture of methyl laurate and methyl myristate, methyl cocoate, ethyl cocoate, isopropyl cocoate, methyl myristate, ethyl myristate, isopropyl myristate, 2-ethyl hexyl acetate.
